(19) United States
(12) Patent Application Publication
(10) Pub. No.: US 2011/0232841 A1
(43) Pub. Date: Sep. 29, 2011

(54) SEMICONDUCTOR WAFER MOUNTING METHOD AND SEMICONDUCTOR WAFER MOUNTING APPARATUS

(76) Inventors: Masayuki Yamamoto, Osaka (JP); Saburo Miyamoto, Kameyama-shi (JP)

(21) Appl. No.: 13/050,882

(22) Filed: Mar. 17, 2011

(30) Foreign Application Priority Data
Mar. 23, 2010 (JP) 2010-066506

(51) Int. Cl. B29C 65/50; B32B 37/10

(52) U.S. Cl. 156/285; 156/510

(57) ABSTRACT

An elastic body approximately throughout a holding region of a semiconductor wafer is provided in a recess at a center of a holding table that holds the semiconductor wafer. An adhesive tape is joined over a rear face of the semiconductor wafer and a ring frame by rolling a joining roller while the elastic body receives and supports a surface of the semiconductor wafer as a circuit surface.

### BACKGROUND OF THE INVENTION

(1) Field of the Invention

This invention relates to a semiconductor wafer mounting method and apparatus for joining an adhesive tape (a dicing tape) over a semiconductor wafer (hereinafter, appropriately referred to as a “wafer”) and a ring frame to manufacture a mount frame.

(2) Description of the Related Art

High-temperature processing such as gold evaporation is recently performed to a rear face of a thinned wafer through back grinding process. In such case, an adhesive tape joined to a surface of the wafer for circuit protection is separated, and thereafter high-temperature processing is performed.

The high-temperature processed wafer is transported to a mounting process. In this process, the wafer is adhesively held on the ring frame via the adhesive tape, whereby a mount frame is manufactured. On the other hand, the wafer may be transported to the mounting process with the surface thereof exposed having no adhesive tape for protection.

Where the wafer is mounted with the circuit surface thereof being exposed, the wafer is placed and held on the holding table such that the circuit surface thereof is directed downward, and the adhesive tape is joined to the rear face thereof. In this case, the following method is known as an example for joining the adhesive tape. That is, the holding table has an annular suction portion formed on an outer periphery thereof, the suction portion having a recess inside. Specifically, the annular suction portion suction-holds an outer periphery of the wafer, and fluid is supplied to the recess for balancing with joining pressure applied on the rear face of the wafer. Consequently, pressure within the recess is controlled. See Japanese Patent Publication No. S62-287639.

The surface-protection adhesive tape may be joined again to the surface of the wafer for proceeding to the mounting step.

The outer periphery on the surface of the wafer, however, directly contacts the annular suction portion of the holding table having high rigidity. Bumps formed up to the outer periphery of the wafer may possibly be broken due to contact to the annular suction portion. Moreover, portions except the outer periphery of the wafer do not contact the annular suction portion, which prevents breakage of bumps through the contact. Pressure within the recess, however, needs to be controlled such that the thinned wafer having reduced rigidity may not be bent and deformed greatly, which control is extremely difficult for realization.

Moreover, where the adhesive tape protects the surface of the wafer, no damage occurs in the surface of the wafer from direct contact thereof to the holding table. The wafer is however nipped with a metal or ceramic holding table having high rigidity and a joining roller. Accordingly, a minute circuit or bumps formed on the surface of the wafer may be deformed or broken.

### SUMMARY OF THE INVENTION

This invention has one object to provide a semiconductor wafer mounting method and apparatus for joining an adhesive tape over a semiconductor wafer and a ring frame with high accuracy to manufacture a mount frame without breakage of the semiconductor wafer itself or a circuit or bump formed on a surface of the semiconductor wafer.

This invention discloses a semiconductor wafer mounting method for joining an adhesive tape over a semiconductor wafer and a ring frame to manufacture a mount frame. The method includes the step of providing an air-permeable elastic body in a holding region of a holding table that suction-holds the semiconductor wafer, and joining the adhesive tape over a rear face of the semiconductor wafer and the ring frame by rolling a joining roller while a circuit surface of the semiconductor wafer is suction-held on the holding table via the elastic body.

According to this method, the elastic body is deformed elastically due to pressure from the joining roller, and the adhesive tape is joined to the surface of the semiconductor wafer with the restoring force in the elastic body. In this process, the semiconductor wafer does not contact the holding table directly having high rigidity. In other words, the semiconductor wafer elastically held is not bent and deformed greatly. Consequently, suppression may be realized of deformation or breakage in the circuit or bump on the wafer surface.

This invention may also include a restricting member along an outer periphery of the elastic body. The restricting member restricts displacement of the semiconductor wafer or the joining roller into an adhesive tape pressing direction.

In such case, pressure of the joining roller may achieve suppression of great bending and deformation in the outer periphery of the semiconductor wafer on a side where joining of the adhesive tape to the semiconductor wafer is initiated or a side on the end of the wafer where the joining is completed.

Moreover, this invention may include the restricting member that receives and supports the outer periphery of the semiconductor wafer.

That is, where the semiconductor wafer has a bump formed on the outer periphery on the surface thereof, the semiconductor wafer is held with the outer periphery thereof protruding beyond the elastic body. The adhesive tape may be joined to the outer periphery on the surface of the semiconductor wafer without directly contacting to the holding table having high rigidity. In addition, the restricting member receives and supports the outer periphery of the semiconductor wafer for suppression of great bending and deformation. As a result, effective suppression may be realized of deformation or breakage in the circuit or bump formed on the outer periphery on the surface of the semiconductor wafer.

Moreover, this invention may include the restricting member provided outside of the semiconductor wafer close to the outer periphery thereof for receiving falling of the joining roller.

In such case, unnecessary displacement of the joining roller may be prevented in the tape pressing direction outside of the semiconductor wafer. Moreover, great bending and deformation may be suppressed in the outer periphery of the semiconductor wafer.

Moreover, in this invention, the restricting member is adjustable in level in accordance with the level of the semiconductor wafer.

In such case, elastic deformation of the elastic body due to pressure in joining of the adhesive tape may be restricted by an appropriate amount in accordance with a thickness of the semiconductor wafer. That is, great bending and deformation may be suppressed of the outer periphery of the semiconductor wafer. The adhesive tape may be joined to the entire rear face of the semiconductor wafer with appropriate pressure.

This invention also discloses semiconductor wafer mounting apparatus for joining an adhesive tape over a semiconductor wafer and a ring frame to manufacture a mount frame. The apparatus includes a holding table for holding the semiconductor wafer and the ring frame having an elastic body on a holding region of the semiconductor wafer; a joining unit provided with a joining roller for rolling over the semiconductor wafer and the ring frame; and a tape cutting mechanism for cutting the adhesive tape along a contour of the ring frame.

With this configuration, the above method may suitably be performed. Furthermore, the foregoing configuration preferably includes a restricting member for restricting displacement of the semiconductor wafer or the joining roller in an adhesive tape pressing direction.

Where the elastic body has a diameter smaller than the semiconductor wafer, the restricting member is configured to receive and support the outer periphery of the semiconductor wafer. The restricting member may be provided outside of the semiconductor wafer close to the outer periphery thereof. Moreover, the restricting member may be molded with an elastic body so as to be adjustable in level.

Additional features of the invention will be preset forth in the description which follows, and in part will be apparent from the description, or may be learned by practice of the invention.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a plan view of semiconductor wafer mounting apparatus.

FIG. 2 is a front view of the semiconductor wafer mounting apparatus.

FIG. 3 is a front view partly showing a workpiece transport device.

FIG. 4 is a plan view partly showing the workpiece transport device.

FIG. 5 is a front view of a wafer transport mechanism.

FIG. 6 is a plan view showing a principal portion of the wafer transport mechanism.

FIG. 7 is a plan view showing forward/backward movement structures of the wafer transport mechanism and a ring frame transport mechanism.

FIGS. 8 and 9 are front views each partially showing forward/backward movement structures of the wafer transport mechanism and the ring frame transport mechanism.

FIG. 10 is a front view of the frame transport mechanism.

FIG. 11 is a plan view of an adhesive tape joining section.

FIG. 12 is a front view of the adhesive tape joining section.

FIG. 13 is a perspective view of a holding table.

FIG. 14 is a plan view of the holding table.

FIG. 15 is a longitudinal sectional front view of the holding table that holds a workpiece.

FIGS. 16 through to 19 are front views each showing an adhesive tape joining process.

FIG. 20 is a perspective view of a mount frame from a surface thereof.

FIG. 21 is a perspective view of the mount frame from a rear face thereof.

FIGS. 22 and 23 are longitudinal sectional front views each showing a holding table in another embodiment.

### DESCRIPTION OF THE PREFERRED EMBODIMENTS

One embodiment of the present invention is now described below with reference to the drawings.

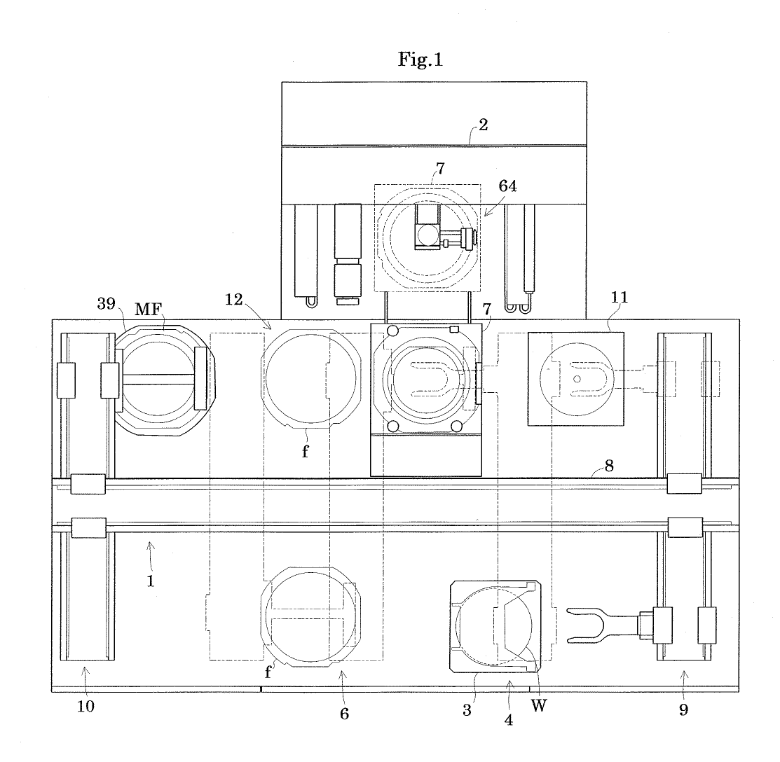

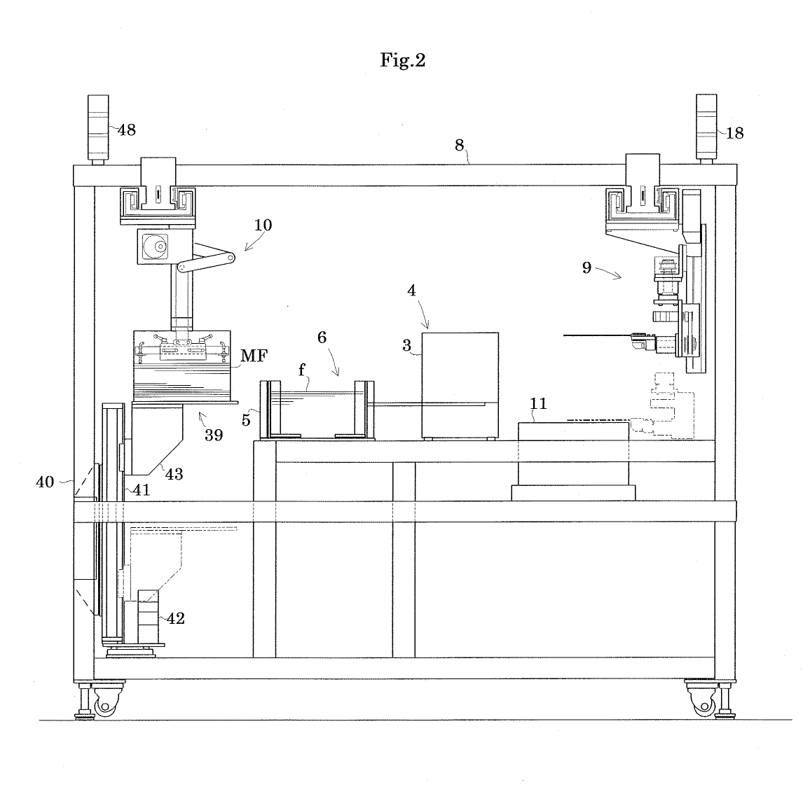

FIG. 1 is a plan view of semiconductor wafer mounting apparatus according to this invention. FIG. 2 is a front view thereof.

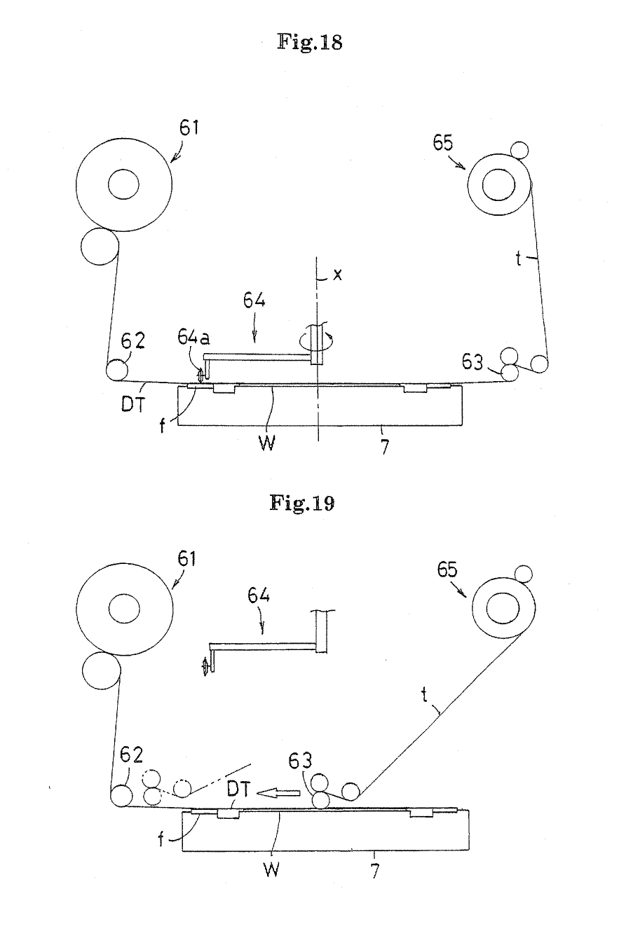

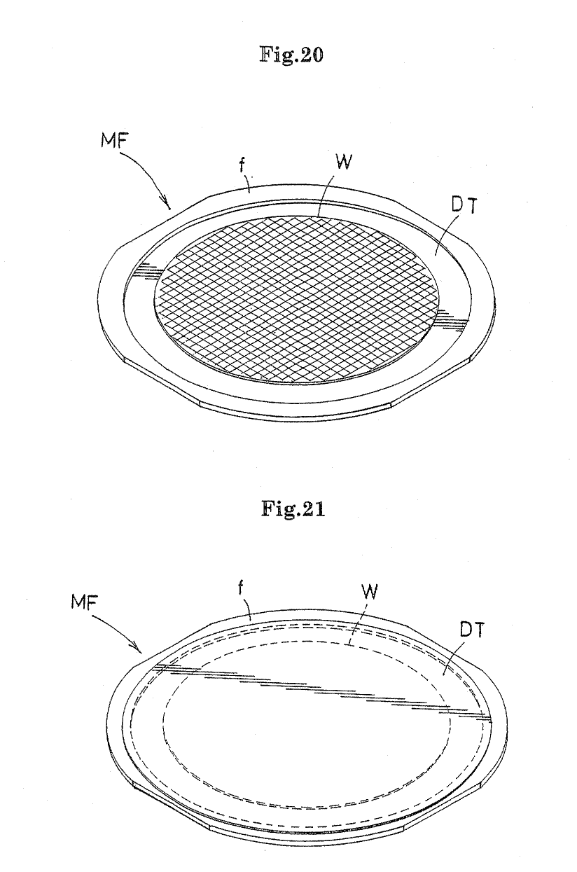

As shown in FIG. 20, the semiconductor wafer mounting apparatus joins an adhesive tape DT over a ring frame f and a semiconductor wafer W (hereinafter, simply referred to as a “wafer W”) having an exposed circuit pattern formed on a surface thereof for manufacturing a mount frame MF.

As shown in FIGS. 1 and 2, a workpiece transport device 1 extends horizontally. An adhesive tape joining section 2 is disposed rearward from the center of the workpiece transport device 1. Herein, the adhesive tape joining section 2 joins the adhesive tape DT to the ring frame f and the wafer W to manufacture the mount frame MF.

A wafer supply section 4 is disposed at a rightward front side with respect to the center of the longitudinal apparatus. The wafer supply section 4 includes a cassette 3 that houses wafers W in a stack manner for supplying them. Moreover, a frame supply section 6 is disposed at a leftward front side with respect to the center of the longitudinal apparatus. The frame supply section 6 includes a cassette 5 that houses ring frames fin a stack manner for supplying them. Further, a holding table 7 is disposed at a rear side near the center of the apparatus so as to move in a forward/backward direction. Herein, the holding table 7 transfers the wafer W and the ring frame f each placed thereon to the adhesive tape joining section 2.

The workpiece transport mechanism 1 includes a wafer transport mechanism 9 and a frame transport mechanism 10. The wafer transport mechanism 9 is supported at a right side of a guide rail 8 so as to reciprocate horizontally. Herein, the guide rail 8 extends horizontally. The frame transport mechanism 10 is supported at a left side of the guide rail 8 so as to move horizontally. Moreover, an aligner 11 is provided at a rightward rear side of the apparatus. Herein, the aligner 11 performs alignment of the wafer W with a notch or an orientation mark. Further, an aligner 12 is provided at a rear side of the frame supply section 6, and performs alignment of the ring frame f.

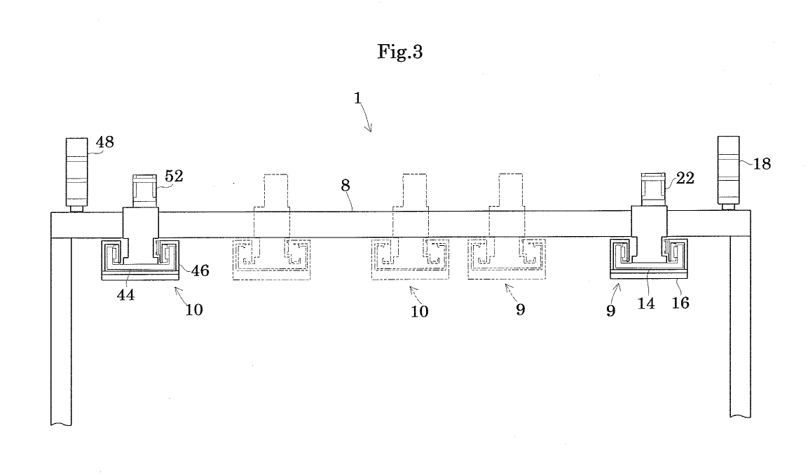

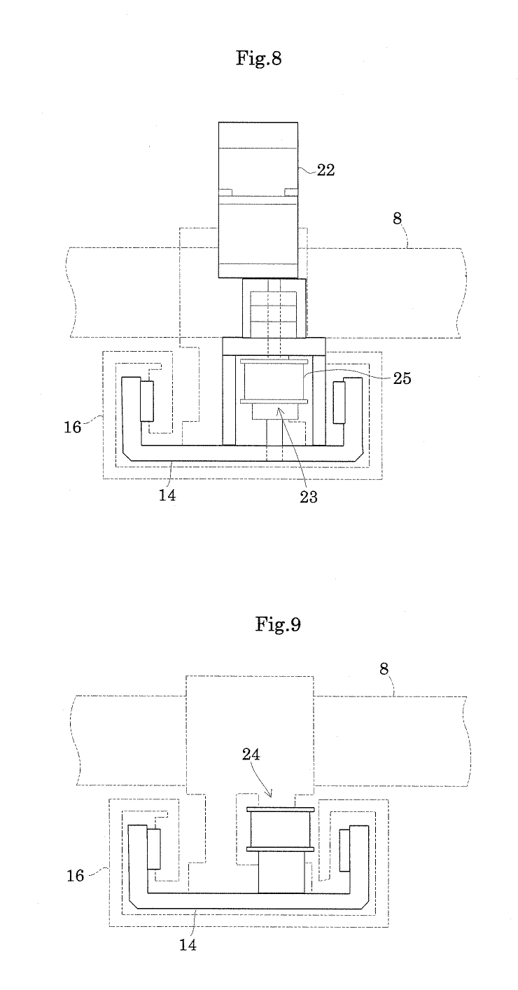

The wafer transport mechanism 9 pulls out a wafer W from the cassette 3, and then transports the wafer W in the forward/backward and horizontal directions. Further, the wafer transport mechanism 9 may turn the wafer W upside down. FIGS. 3 to 9 show a detailed structure of the workpiece transport device 9.

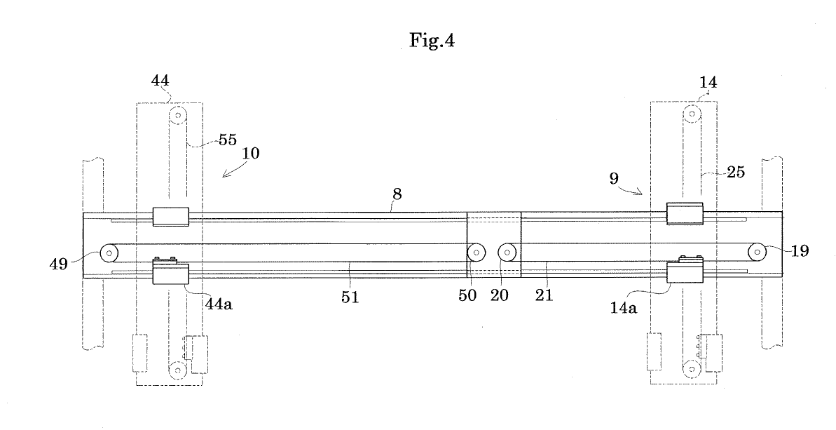

As shown in FIGS. 3 and 4, the wafer transport mechanism 9 includes a horizontally movable table 14 that moves horizontally along the guide rail 8. The wafer transport mechanism 9 also includes a forward/backward movable table 16 that moves forward/backward along a guide rail 15 provided in the horizontally movable table 14. The wafer transport mechanism 9 also includes a wafer holding unit 17 provided below the forward/backward movable table 16 so as to move vertically.

A driving pulley 19 is pivotally supported near a right end of the guide rail 8 and is driven by a motor 18 so as to rotate forward/backward. Moreover, an idling pulley 20 is pivotally supported near a center of the guide rail 8. Further, a belt 21 is wound between the driving pulley 19 and the idling pulley 20. A slide engagement section 14a in the horizontally movable table 14 is connected to the belt 21. Consequently, the belt 21 rotates forward/backward, and accordingly the horizontally movable table 14 moves horizontally.

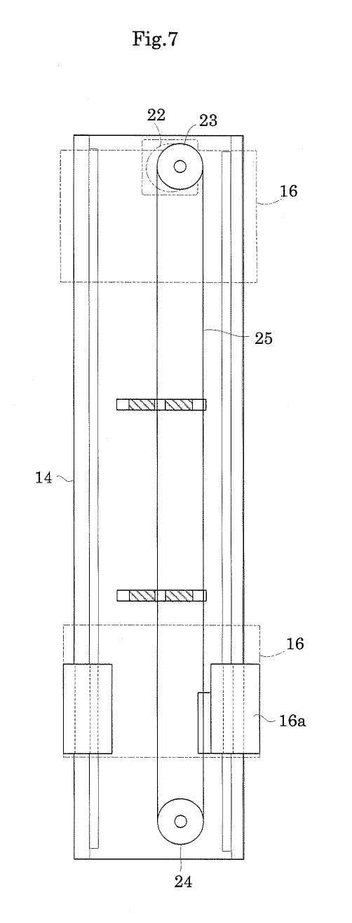

As shown in FIGS. 7 through 9, a driving pulley 23 is pivotally supported near a rear end of the horizontally movable table 14 and is driven by a motor 22 so as to rotate forward/backward. Moreover, an idling pulley 24 is pivotally supported near a front end of the horizontally movable table 14. Further, a belt 25 is wound between the driving pulley 23 and the idling pulley 24. A slide engagement section 16a in the forward/backward movable table 16 is connected to the belt 25. The belt 25 rotates forward/backward, and accordingly the horizontally movable table 16 moves horizontally.

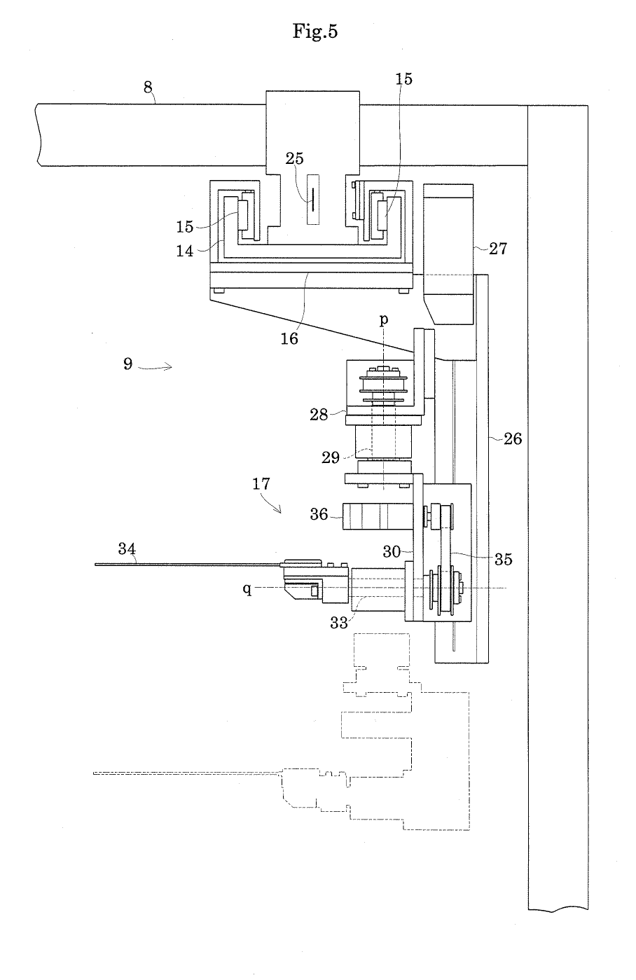

As shown in FIG. 5, the wafer holding unit 17 includes an inverted L-shaped support frame 26, a lifting table 28, a turning table 30, a pivoting motor 32, a wafer holding arm 34, and a reverse rotating motor 36. The support frame 26 is connected to a lower surface of the horizontally movable table 16. A motor 27 drives the lifting table 28 in a screw feed manner along a vertical frame of the support frame 26. The turning table 30 is pivotablly supported via a turning axis 29 for pivoting about a vertically oriented axis p. The pivoting motor 32 is wound around the turning axis 29 via a belt 31 for interlocking with each other. The wafer holding arm 34 is supported on a lower surface of the turning table 30 for reverse rotation about a horizontal axis q. The reverse rotating motor 36 is wound around the turning axis 33 via a belt 35 for interlocking with each other.

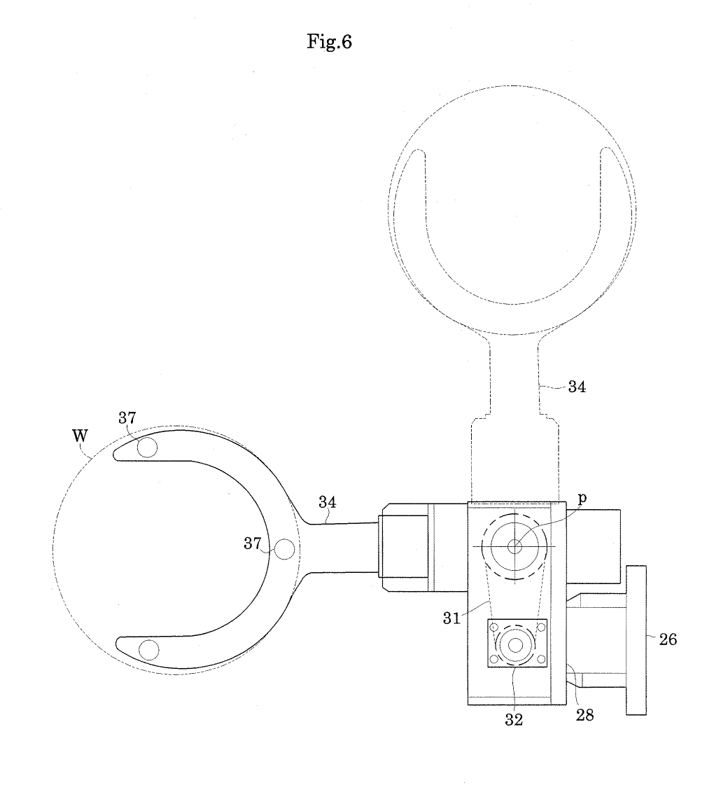

As shown in FIG. 6, the wafer holding arm 34 has U-shaped suction portions 34a having vacuum suction holes 37 formed therein at a tip end of the wafer holding arm 34. Use of the movable structure described above may achieve the following advantages. That is, the wafer W suction-held with the wafer holding arm 34 may be moved in forward/backward and horizontal directions, and may be turned about the vertically-oriented axis p with the holding arm 34. The wafer W may also be turned upside down through the reverse rotation about the horizontally-oriented axis q.

As shown in FIG. 2, a collection section 39 is disposed at a left side of the frame supply section 6 for collecting to stack manufactured mount frames MF. The collection section 39 includes an upright rail 41 coupled to and fixed on an apparatus framework 40, and a lifting table 43 driven by a motor 42 so as to move vertically in a screw feed manner along the upright rail 41. Accordingly, the frame supply section 6 allows the mount frame MF to be placed on the lifting table 43 and to move downward in a pitch feed manner.

The frame transport mechanism 10 pulls out an uppermost one of stacked ring frames f from the frame supply section 6 in succession, and then transports each ring frame fin the horizontal and forward/backward directions. The horizontal and forward/backward movement structures of the ring frame transport device 10 are similar to those of the wafer transport mechanism 9.

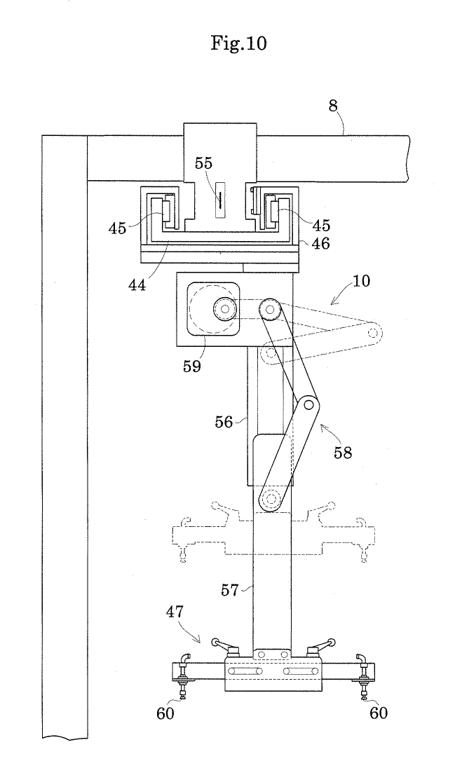

As shown in FIGS. 7 and 10, specifically, the frame transport mechanism 10 includes a horizontally movable table 44 that extends and moves horizontally along the guide rail 8. The frame transport mechanism 10 also includes a forward/backward movable table 46 that moves forward/backward along a guide rail 45 in the horizontally movable table 44. The ring frame transport device 10 also includes a ring frame holding unit 47 that is provided below the forward/backward movable table 46 so as to move vertically.

As shown in FIGS. 3 and 4, a driving pulley 49 is pivotally supported near a left end of the guide rail 8 and is driven by a motor 48 so as to rotate forward/backward. Moreover, an idling pulley 50 is pivotally supported near the center of the guide rail 8. Further, a belt 51 is wound between the driving pulley 49 and the idling pulley 50. A slide engagement section 44a in the horizontally movable table 44 is connected to the belt 51. The belt 51 rotates forward/backward, and accordingly the horizontally movable table 44 moves horizontally.

Herein, the configuration shown in FIGS. 7 through 9 for describing the wafer transport mechanism 9 is applied to the description on the frame transport mechanism 10. That is, a driving pulley 53 is pivotally supported near a rear end of the horizontally movable table 44, and is driven by a motor 52 so as to rotate forward/backward. Moreover, an idling pulley 54 is pivotally supported near the rear end of horizontally movable table 44. Further, a belt 55 is wound between the driving pulley 53 and the idling pulley 54. A slide engagement section 46a in the forward/backward movable table 46 is connected to the belt 55. The belt 55 rotates forward/backward, and accordingly the forward/backward movable table 46 moves forward/backward.

As shown in FIG. 10, the frame holding unit 47 includes an upright frame 56 connected to a bottom side of the forward/backward movable table 46, a lifting frame 57 supported so as to slide vertically along the upright frame 56, a bendable link mechanism 58 for moving the lifting frame 57 vertically, a motor 59 for bending the bendable link mechanism 58 forward/backward, and suction pads 60 provided at corners on lower ends of the lifting frame 57. Accordingly, the suction pads 60 suction-hold stacked ring frames fin order from an uppermost one that are stacked on the lifting table 43, and then move upward. Thus, the ring frames f may be transported forward/backward and horizontally. Herein, the suction pad 60 may slode horizontally in accordance with a size of a ring frame f.

The wafer transport apparatus 1 is configured as described above. A wafer W and a ring frame f are transported to the adhesive tape joining section 2 as follows. In the wafer transport mechanism 9, first, the wafer holding arm 34 suction-holds a wafer W and transports the wafer W to the aligner 11. Next, the aligner 11 performs alignment of the wafer W placed thereon. After performance of the alignment, the wafer holding arm 34 again suction-holds the wafer W and turns it upside down. The wafer W having the surface directed downward is transported and placed onto the holding table 7.

In the frame transport mechanism 10, on the other hand, each suction pad 60 suction-holds a ring frame f and transports the ring frame f to the aligner 12. Next, the aligner 12 performs alignment of the ring frame f placed thereon. Next, each suction pad 60 again suction-holds the ring frame f subjected to the alignment, transfers the ring frame f to the holding table 7, and places the ring frame f on the holding table 7 such that the ring frame f is concentric with the wafer W.

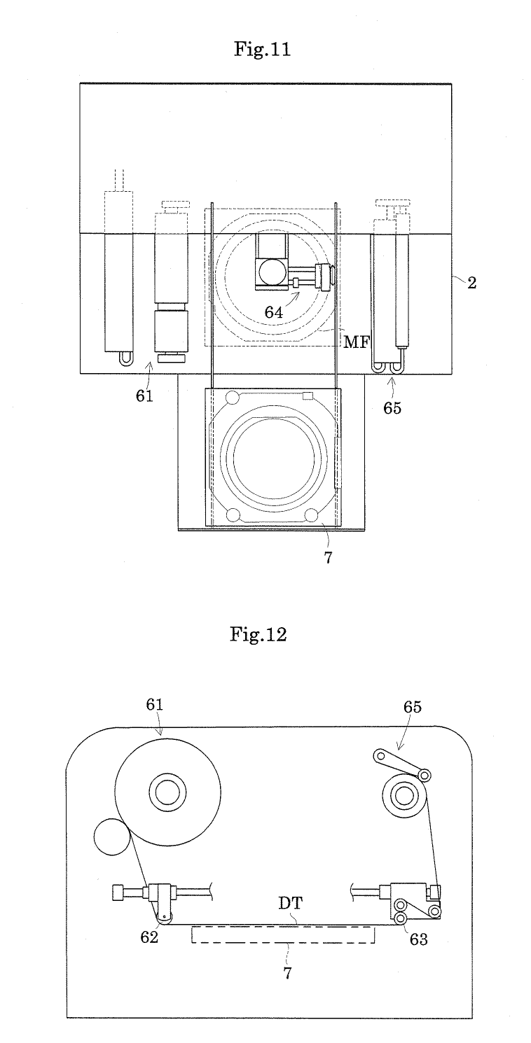

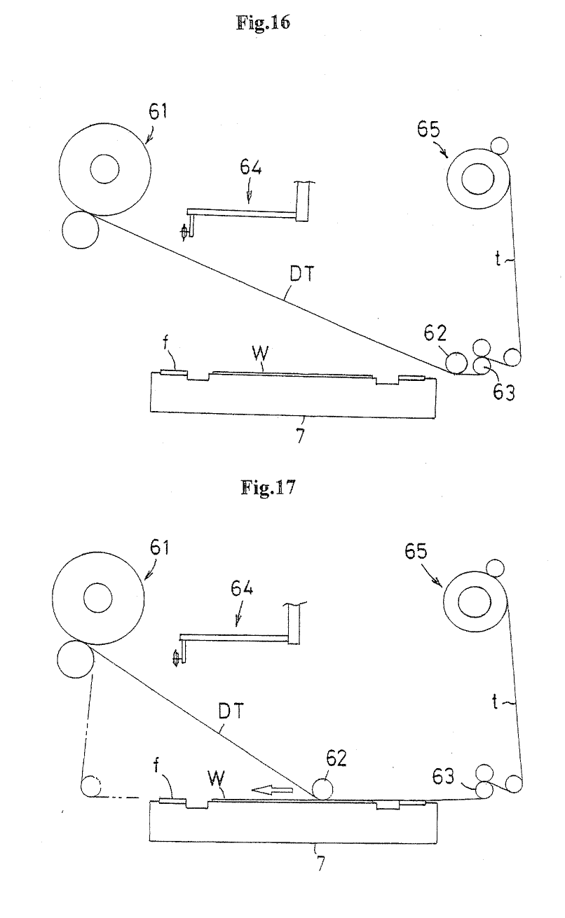

As shown in FIGS. 11 and 12, the adhesive tape joining section 2 includes a tape supply section 61 that houses a wide adhesive tape (a dicing tape) DT in a roll form, a joining roller 62, a separation roller 63, a tape cutting mechanism 64, and a tape collection section 65. FIGS. 16 to 19 are schematic views each showing a proces of joining the adhesive tape DT.

As shown in FIG. 16, the joining roller 62 and the separation roller 63 are in a standby position. Moreover, the tape cutting mechanism 64 is in a standby position. In this state, the holding table 7 having the wafer W directed downward and the ring frame f placed thereon reaches a tape joining position.

Subsequently, as shown in FIG. 17, the joining roller 62 in its standby position moves forward to join the adhesive tape DT over the wafer W and the ring frame f. Upon completion of joining the adhesive tape DT, a round blade 64a in the tape cutting mechanism 64 moves downward and turns about an axis x concentric with the wafer W, as shown in FIG. 18. The round blade 64a turns to cut the adhesive tape DT joined to the ring frame f into a circle having a diameter larger than the inner diameter of the ring frame f. Thereafter, the separation roller 63 rolls forward as shown in FIG. 19 to separate an unnecessary portion of the cut adhesive tape DT located outside a cutting line from the ring frame f. Accordingly, the mount frame MF directed downward remains on the holding table 7, as shown in FIG. 21. The holding table 7 having downward-directed mount frame MF held thereon moves from the tape joining position toward a front side with respect to the apparatus. Meanwhile, each of the joining roller 62 and the separation roller 63 returns to its initial position. Simultaneously, the adhesive tape DT fed out from the tape supply section 61 is supplied above the tape joining position, whereas an unnecessary tape t to is wound and collected in the tape collecting section 65.

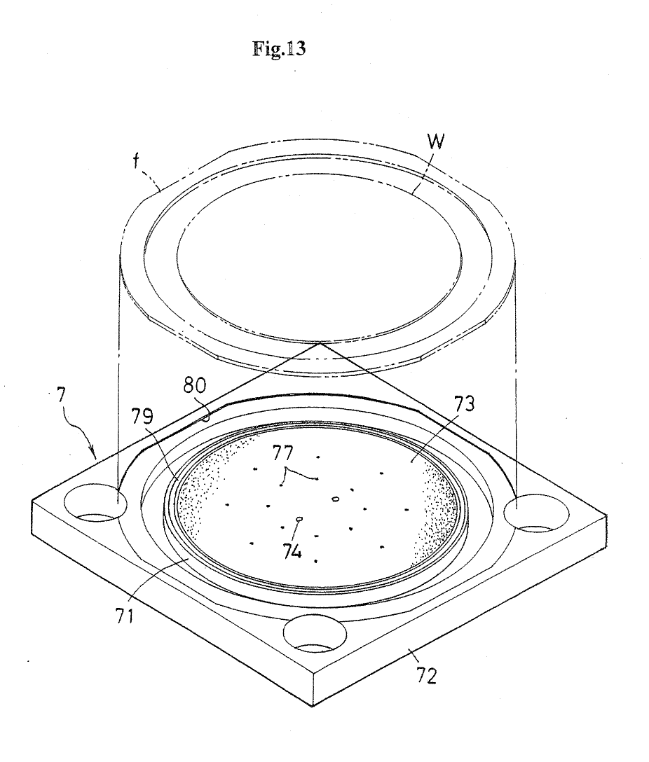

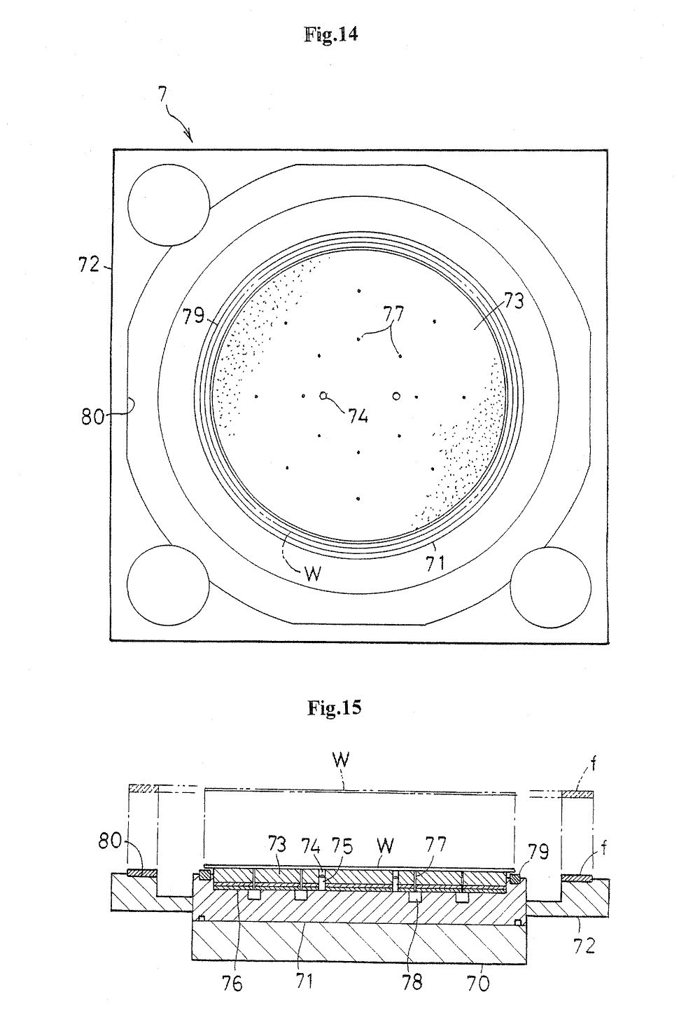

Each of FIGS. 13 to 15 shows a detail configuration of the holding table 7 in the adhesive tape joining section 2.

The holding table 7 has a wafer supporting pedestal 71 and a frame holder 72. The wafer supporting pedestal 71 in a circular shape is mounted and connected onto a base 70. The frame holder 72 in an annular shape surrounds the wafer supporting pedestal 71.

The wafer supporting pedestal 71 has a circular recess on the upper surface thereof. The recess has an elastic body 73 fitted thereinto having a slightly smaller diameter than the outer diameter of the wafer W. The elastic body 73 is composed of a closed-cell foamed rubber sponge or a silicon rubber having a thickness of several millimeters. The elastic body 73 has a pair of engaging holes 74 formed close to the center thereof for fixation into alignment pins 75 provided on the upper surface of the holding table. Here, the elastic body 73 is held at a constant attitude of protruding through the surface of the table. In addition, an adjustment sheet 76 is covered under the elastic body 73 so as to have any thicknesses for adjusting the level of the upper surface of the elastic body 73 in accordance with the thickness of the wafer. The adjustment allows the upper surface of the wafer W on the elastic body 73 to have a level slightly higher than that of the ring frame f on the frame holder 72.

The elastic body 73 and the adjustment sheet 76 have suction holes 77 formed therein. The suction holes 77 are in communication with a vacuum device via suction grooves 78 formed on the upper surface of the table. Consequently, the wafer W may be suction-held on the upper surface of the elastic body 73.

An annular restricting member 79 is placed close to the outer periphery of the elastic body 73 adjacent to the outer periphery on the upper surface of the wafer supporting pedestal 71. The restricting member 79 is formed of a silicon rubber having appropriate elasticity. The restricting member 79 has an upper surface that is directed toward the lower surface of the outer periphery of the wafer W protruding beyond the elastic body 73.

The frame holder 72 has a step 80 formed on the upper surface thereof with the same contour as the ring frame f. Fitting of the ring frame f into the step 80 may realize concentric alignment of the ring frame f with the wafer W.

The holding table 7 is configured as following. In the adhesive tape joining process mentioned above, the elastic body 73 is deformed elastically due to pressure from the joining roller 62. According to the elastic deformation, the wafer W falls into a level equal to that of the ring frame f. That is, the adhesive tape DT is joined to the upper surface (rear surface) of the wafer with given pressure.

Moreover, the restricting member 79 receives a portion of the wafer W protruding beyond the outer periphery thereof that occurs due to falling of the wafer W. Accordingly, the restoring force in the restricting member may restrict falling of the portion projecting beyond the outer periphery of the wafer W below the level of the upper surface of the ring frame f.

According to the apparatus in the foregoing exemplary embodiment, the elastic body 73 and the restriction member 79 receive the wafer W, whereby damages may be suppressed occurring from improper falling of the outer periphery of the wafer adjacent to the adhesive tape joining start position to the wafer W.

This invention may be embodied as follows.

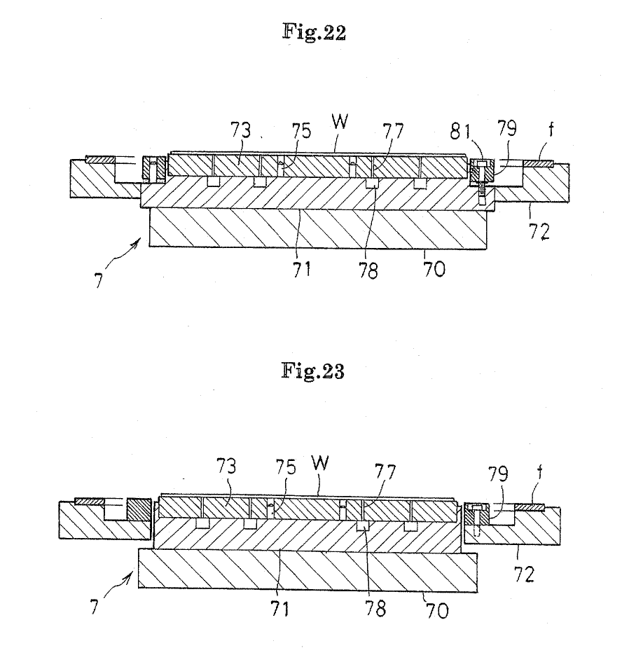

FIG. 22 shows one embodiment of the holding table 7 suitable in a case where the wafer surface has bumps on the outer periphery thereof.

In this case, the elastic body 73 has a diameter equal or slightly larger than the outer diameter of the wafer W such that the outer periphery on the surface of the wafer W does not protrude. Moreover, the annular restricting member 79 is arranged adjacent outside of the wafer W to surround the elastic body 73. Here, the restriction member 79 has the upper surface subject to a non-adhesive treatment so as to remove the adhesive tape DT readily. The restricting member 79 also restricts falling of the joining roller 62. That is, pressure of the joining roller 62 may prevent the outer periphery of the wafer W from being greatly bent and deformed.

The restricting member 79 is attached so as to be adjustable in level through an adjustment bolt 81. Specifically, the position in level of the upper surface of the restricting member 79 is adjusted in accordance with the thickness of the wafer W, whereby the downward displacement amount of the wafer W may be restricted during joining of the adhesive tape DT. Adjustment of the displacement amount may realize uniform joining of the adhesive tape DT over the rear surface of the wafer W with appropriate pressure.

FIG. 23 shows another embodiment of the holding table 7 suitable in a case where the wafer surface has bumps on the outer periphery thereof.

Here in this case, the base 70 is configured adjustable in vertical position, and the restriction member 79 is attached to the fixed frame holder 72. That is, level adjustment of the wafer supporting pedestal 71 may perform positional adjustment of the upper surface of the restricting member 79 in accordance with the thickness of the wafer. In this configuration, the restricting member 79 also restricts falling of the joining roller 62. Consequently, the outer periphery of the wafer W may be prevented from being greatly bent and deformed. Moreover, the downward displacement amount of the wafer W may be restricted during joining of the adhesive tape DT. Adjustment of the displacement amount may realize uniform joining of the adhesive tape DT over the rear surface of the wafer W with appropriate pressure.

According to the apparatus in the foregoing exemplary embodiment, a closed-cell foamed rubber sponge having high air-permeability only in a thickness direction may be used as the elastic body. In this case, the wafer W may be suction-held on the entire surface of the elastic body 73 having no suction-hole 77 formed therein. Here, the closed-cell foamed rubber sponge has air-permeability only in a vertical direction. Consequently, no suction force from the outer periphery may occur in suction-holding of the wafer via the closed-cell formed rubber sponge.

The foregoing exemplary embodiment may have an aspect of suction-holding the wafer W and the ring frame f on the under surface of the holding table 7 for joining the adhesive tape from below.

This invention is applicable to a case where mounting process is performed to a wafer W having a circuit-protection adhesive tape joined to a surface thereof.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A semiconductor wafer mounting method for joining an adhesive tape over a semiconductor wafer and a ring frame to manufacture a mount frame, the method comprising the step of:
providing an air-permeable elastic body in a holding region of a holding table that suction-holds the semiconductor wafer, and joining the adhesive tape over a rear face of the semiconductor wafer and the ring frame by rolling a joining roller while a circuit surface of the semiconductor wafer is suction-held on the holding table via the elastic body.

2. The semiconductor wafer mounting method according to claim 1, wherein
a restricting member is provided along an outer periphery of the elastic body for restricting displacement of the semiconductor wafer or the joining roller into an adhesive tape pressing direction.

3. The semiconductor wafer mounting method according to claim 2, wherein
the restricting member receives and supports the outer periphery of the semiconductor wafer.

4. The semiconductor wafer mounting method according to claim 2, wherein
the restricting member is provided outside of the semiconductor wafer close to the outer periphery thereof for receiving falling of the joining roller.

5. The semiconductor wafer mounting method according to claim 4, wherein
the restricting member is adjustable in level in accordance with the level of the semiconductor wafer.

6. Semiconductor wafer mounting apparatus for joining an adhesive tape over a semiconductor wafer and a ring frame to manufacture a mount frame, comprising:
a holding table for holding the semiconductor wafer and the ring frame having an elastic body on a holding region of the semiconductor wafer;
a joining unit provided with a joining roller for rolling over the semiconductor wafer and the ring frame; and
a tape cutting mechanism for cutting the adhesive tape along a contour of the ring frame.

7. The semiconductor wafer mounting apparatus according to claim 6, further comprising:
a restricting member for restricting displacement of the semiconductor wafer or the joining roller in an adhesive tape pressing direction.

8. The semiconductor wafer mounting apparatus according to claim 7, wherein
the elastic body has a diameter smaller than the semiconductor wafer, and
the restricting member receives and supports the outer periphery of the semiconductor wafer.

9. The semiconductor wafer mounting apparatus according to claim 8, wherein
the restricting member is provided outside of the semiconductor wafer close to the outer periphery thereof.

10. The semiconductor wafer mounting apparatus according to claim 7, wherein
the restricting member is molded with an elastic body so as to be adjustable in level.

11. The semiconductor wafer mounting apparatus according to claim 7, wherein
the holding table has alignment pins, and
the elastic body has engaging holes for fixation into the alignment pins.

12. The semiconductor wafer mounting apparatus according to claim 7, wherein
an adjustment sheet is provided between a holding region of the holding table and the elastic body for adjusting the level of the elastic body.

13. The semiconductor wafer mounting apparatus according to claim 7, wherein
the elastic body is a closed-cell foamed rubber sponge having high air-permeability only in a thickness direction thereof.
